(19) United States
(12) Patent Application Publication
(10) Pub. No.: US 2024/0052437 A1
(43) Pub. Date: Feb. 15, 2024

(54) A PROCESS OF TANNING ANIMAL HIDES

(71) Applicant: ECCO Sko A/S, Bredebro (DK)

(72) Inventors: Thomas Gogsig, Bredebro (DK); Panagiotis Mytaros, Bredebro (DK); Thomas Gregor, Bredebro (DK); Ilona Francisca Maria Coremans, Bredebro (DK)

(21) Appl. No.: 18/267,069

(22) PCT Filed: Dec. 14, 2021
(86) PCT No.: PCT/DK2021/050366

§ 371 Date: Jun. 13, 2023

(30) Foreign Application Priority Data
Dec. 14, 2020 (DK) PA 2020 70830

(51) Int. Cl. C14C 3/06; C14C 15/00

(52) U.S. Cl. CPC C14C 3/06; C14C 15/00

(57) ABSTRACT

A tanning process for tanning of animal hides in a process equipment including a tanning container, a controller, and temperature regulating equipment. The controller controls the temperature in the tanning container based on a temperature setpoint input to or established by the controller. The tanning process includes the steps of initially determining process parameters based on animal hide characteristics including at least animal hide type and animal hide weight. The process parameters include at least one of the parameters: time, temperature, start pH and end pH or any combination thereof. The tanning process of the animals hides is executed based on the process parameters in the tanning container under atmospheric pressure. The tanning process involves the addition of tanning agents to animal hides in the tanning container. The tanning involves the addition of water in an amount of less than 10% bw of the animal hides.

### FIELD OF THE INVENTION

The invention relates to a process of tanning animal hides according to claim 1.

### BACKGROUND OF THE INVENTION

Tanning processes of animal hides have been known for ages and chrome tanning has become the most important tanning method in conventional leather manufacturing. However, the absorption rate of the tanning agent in the traditional chrome tanning process is only 65-75%. A large amount of chrome is not absorbed by the leather and discharged with the wastewater, which not only increases the pollution load of the tanning wastewater, but also wastes valuable chrome resources. Several optimized tanning methods are known in the field of tanning leather; however, these methods require special tanning agents or specialized tanning equipment.

### SUMMARY OF THE INVENTION

The invention relates to a tanning process for tanning of animal hides in a process equipment PE the process equipment including a tanning container TC, a controller CON and temperature regulating equipment TRE, the controller CON controlling the temperature in the tanning container TC on the basis of temperature setpoint input to or established by the controller CON the tanning process comprising the steps of
initially determining process parameters PP on the basis of animal hide characteristics AHC, the animal hide characteristics AHC including at least animal hide type and animal hide weight,
the process parameters PP including at least one of the parameters: time, temperature, start pH and end pH or any combination thereof,
executing the tanning process of the animals hides on the basis of said process parameters PP in said tanning container under atmospheric pressure,
   wherein said tanning process involves addition of tanning agents to said animal hides AH in said tanning container TC
   and wherein the tanning involves addition of water in an amount of less than 10% bw of the animal hides.

It is noted that the present process is able to be run in an industrial scale in the sense that selected and required parameters may be preset and the process may then be run accordingly. This has the implication that run-time checking of overload of tanning agent may be avoided and the process may be run much faster and effective, during use of relatively little water. Moreover, the amount wastewater resulting from the tanning process will be minimized and even eliminated because the water remains in the skin.

It is in particular noted that the present invention facilitates a very high load of tanning agent, even when run in industrial scale and with a reduced amount of waste. It is well known from the conventional prior art of water-based tanning to obtain relatively high content of tanning agent in the tanned leather, but in such processes a significant amount of tanning agent must be used during the post-tanning, i.e. after basification performed during the “main” tanning. This has the implication in prior art tanning that the process results in a high amount of post tanning waste, i.e. mixtures of chromium, fatliquors.

Thus, the invention provides for a first tanning of non-tanned pickled hides, which is run in an automated way in the sense the e.g. temperature, temperature profile during the tanning process, during of the tanning process, addition of the required tanning agent may be predetermined and set and complied with during a significant part of the process. This preloading of chromium according to provisions of the invention may then make it possible to obtain the final desired very high load of chromium in a post tanning process using relatively little post tanning agents, such as chromium.

The preloading of chromium according to provisions of the invention may even make it possible to avoid a re-tanning step/re-chroming step during post tanning which highly advantageously results in both the avoidance of a chromium waste water stream during post tanning and further the use of less post tanning chemicals during post tanning. It is possible to use less post tanning chemicals, during the post tanning process, because the advantageously high load of chromium, during the tanning process, generally results in more links to bind the post tanning chemicals in the animal hides and thus the overall concentration of the chemicals is reduced.

Further, due to a high load of fixed chrome in the animal hides, there is a lower concentration of soluble chrome. A too high concentration of soluble chrome will result in un-uniform distribution of chrome throughout the hide where the highest concentration of chrome may be on the flesh side.

It is in particular noted that the process may be run with little or no water added, and preferably also relatively close to atmospheric pressure at the initially determined process parameters or run-time modified process parameters, while still obtaining a very high load of chromium before any post tanning. This high load of chromium prior to post-tanning, based on the process parameters, has the implication that less chromium needs to be added during the more environmentally critical post-tanning. In this context, post-tanning is understood as the process undertaken subsequently to the basification performed at the end of the initial tanning process.

Preferably, the tanning process is performed at least semiautomatic in the sense that parameters such a basification agent is predefined, and that the temperature is either fixed from the beginning of the process or at least maintained according to a preset temperature development throughout the tanning process or at least an initially step of the tanning process. The tanning process may thus be resumed in a further tanning process step after the initial tanning process step determined by the initially determined process parameters one or a number of times. The process parameters of the following (i.e. further) tanning process step(s) may be manually determined, but it is preferred that at least one of the further tanning process steps is executed automatically until the end of the further tanning process step on the basis of either the initially determined process parameters or new determined process parameters determined at latest when the further tanning process step is initiated.

Thus, in an embodiment, the invention provides for an optimized tanning process with maximal absorption of tanning agents and minimal amount of waste products but still using conventional tanning equipment for industrial production.

According to an embodiment of the invention, the animal hides tanned according to the process parameters PP excluding the post-tanning process, reaches a tanning agent content of said animal hides of 3.5-12% bw of said animal hides, such 4-10% bw of said animal hides, such as of 4-8% bw of said animal hides.

According to an embodiment of the invention, the animal hides tanned according to the process parameters PP excluding the post-tanning process, reaches a tanning agent content of said animal hides of 3.5-12% bw of said animal hides, such 4-10% bw of said animal hides, such as of 4-8% bw of said animal hides and wherein the tanning agent is chrome. The process parameters PP related to the present provisions of the application of less than 10% water by weights if the animal hides in the total tanning process (excluding pre-tanning and post-tanning) and the above stated tanning agent content are typically a temperature development (including a constant temperature setting) and a time duration. The initial tanning step should preferably be set as long as possible so to enable an efficient process requiring as little manual interaction as possible without risking irreversible over-saturation of tanning agent.

According to an embodiment of the invention, the tanning involves addition of water in an amount of less than 8% bw of the animal hides, such as less than 5% bw of the animal hides, such as less than 3% bw of the animal hides.

According to an embodiment of the invention, the tanning involves addition of water in an amount of between 3-10% bw of the animal hides, such as between 5-8% bw of the animal hides.

According to an embodiment of the invention, the tanning process comprises a first process and a second process, wherein the first process is the process according to claim 1 and wherein the second process is a subsequent post tanning process.

According to an embodiment of the invention, the animal hide has a flesh side and a grain side, the two sides defining from the flesh side to the grain side a flesh layer FLA a middle layer MLA and a grain layer GLA, and wherein the animal hide comprises a tanning agent uniformly distributed in weight concentration after the first process.

According to an embodiment of the invention, the tanning agent concentration is deviating less than 6% bw between the flesh layer FLA and the middle layer MLA and less than 6% bw between the grain layer GLA and the middle layer MLA, such as less than 5% bw between the flesh layer FLA and the middle layer MLA and less than 5% bw between the grain layer GLA and the middle layer MLA.

According to an embodiment of the invention, the tanning process further includes a post tanning process including the processes of neutralization NEU, retanning RET, dyeing DYE, fatliquoring FAT, setting out SEO and/or sammying SAM.

Retanning may e.g. be run in a different tanning container, if so desired.

According to an embodiment of the invention, the animal hides are tanned according to the process parameters PP including the post-tanning process, reaches a chrome content of said animal hides of between 3.5-12% bw of said animal hides.

According to an embodiment of the invention, the animal hides tanned according to the process parameters PP excluding the post-tanning process, reaches a chrome content of said animal hides of 3.5-12% bw of said animal hides.

An advantage of the invention is that a tanning process, with optimal parameters, on e.g. conventional tanning process equipment, resulting in a maximal and uniform load of tanning agent throughout the animal hides and at the same time preventing an overload of tanning agents resulting in a miscolour of the hide and subsequently leather. By a set of optionally preset process parameters, the tanning process can be executed efficiently in industrial scales with low or eliminated amounts of water, compared to conventional tanning, and with optimised parameters for the most efficient absorption and binding of chrome to the animal hide.

The animal hides to be tanned according to the present invention may typically be pickled animal hides.

In an embodiment of the invention, the animal hides tanned according to the process parameters excluding an optional post-tanning process, reaches a chrome content of said animal hides of 3.5-8% bw of said animal hides, such as 3.5-6% bw of said animal hides.

According to an embodiment of the invention, the animal hide tanned according to the tanning process, including the post-tanning process, has a tanning agent content of said animal hides of between 5.5-12% bw of said animal hides and wherein the tanning agent is uniformly distributed through a cross section of the tanned hide.

In an embodiment of the invention, the animal hides tanned according to the process parameters including an optional post-tanning process, reaches a chrome content of said animal hides of 4 to 8% bw of said animal hides, such as 4 to 6% bw of said animal hides

According to an embodiment of the invention, the process is an automatic tanning process executed in tanning equipment, comprising process parameters PP such as time, temperature, start pH and end pH for at least the initial tanning process step.

Hereby, the tanning process may be a fully automatic process or at least an automatic process with very little manual interruption and test required, where the tanners, performing the tanning process at tanneries, efficiently can complete the tanning processes based on the process parameters. The automatic tanning process may be completed with only minimal intermediate testing of e.g. boiling test, temperature and pH as the process parameters are according the e.g. the type or thickness of the animal hide.

Tanning equipment includes a drum e.g. a tanning drum designed for the animal hides to be injected into the tanning drum, the tanning equipment further includes a temperature control arrangement for determining/controlling the temperature in the tanning drum during the tanning process. A timer may also be included in the tanning equipment for controlling the time in the tanning drum during the tanning process. Tanning equipment further includes a pH controlling arrangement for determining/controlling the pH during the tanning process.

According to an embodiment of the invention, the first process includes basifying the animal hides providing for a modifying and raised pH during the process, thereby modifying the pH through the process from a lower pH valuer to a higher pH at the end of the process.

According to an embodiment of the invention, the animal hide is a bovine hide. According to an embodiment of the invention, the animal hide is a cattle, cow or calf hide.

According to an embodiment of the invention, a preset process parameter of time is between 2-24 hours.

According to an embodiment of the invention, a preset process parameter of temperature is between 30-55 degree Celsius

According to an embodiment of the invention, the start pH of a preset process parameter is between 2.5-5.

According to an embodiment of the invention, start pH of the first process is less than 7, such as less than 6, such as less than 5, such as less than 4, such as less than 3.

It is advantageous for the aqueous solution in the tanning process to have a low pH, e.g. below 4, as the tanning agent, such as chromium sulfate, is soluble in acidic conditions, and is therefore adapted to penetrate the hide in acidic conditions. The pH may be lowered in the process by introducing acids in a single component or as a mixture of acids, where the acids may be e.g. Formic acid (HCOOH) or Sulfuric acid (H2SO4).

According to an embodiment of the invention, pH is controlled actively. Hereby, the pH is controlled by an addition of base. An example hereof may be the addition of Feliderm MgO into the equipment, where the basification process may be run for e.g. 8 hours for the binding of tanning agent in the animal hides.

According to an embodiment of the invention, pH is controlled reactively. Hereby, the pH is controlled by the use of a self-basifying tanning agent. An example hereof may be a self-basifying chrome sulfate, such as e.g. Baychrom A. By use of a self-basifying agent, there may be no need for an additional basifying agent, and the basifying may be obtained by increasing the heat inside the equipment.

According to an embodiment of the invention, the tanning agent may be one or more chemicals that are provided in a mixture or individually.

According to an embodiment of the invention, the tanning agent comprises chrome. According to an embodiment of the invention, the chrome is self-basifying.

Hereby, there may be no need for additional basifying agent, and the basifying may be obtained by increasing the heat inside the container as well as approximately 8 hours of tanning. An example of such self-basifying agent is Baychrom A, which is a self-basifying Chrome Sulfate,

According to an embodiment of the invention, the chrome content in the leather is at least 2%, such as at least 3%, such as at least 4%, such as at least 5%, such as at least 8%, such as between 2%-8%, such as between 4%-6%.

According to an embodiment of the invention, the chrome content in the hides during tanning process is increased at least 2% based on pelt weight, such as at least 3% based on pelt weight, such as at least 5% based on pelt weight.

According to an embodiment of the invention, the post tanning process comprises at least one of the processes of neutralization NEU, retanning RET, dyeing DYE, fatliquoring FAT, sammying SAM, setting SEO and/or drying DRY.

According to an embodiment of the invention, the post tanning process is performed without use of tanning agent.

According to an embodiment of the invention, the tanning agent comprises chrome. According to an embodiment of the invention, the first process makes for at least 95% of the tanning agent contained in the tanned animal hides, such as at least 98% of the tanning agent contained in the tanned animal hides.

According to an embodiment of the invention, the first process makes for 100% of the tanning of the animal hides.

According to an embodiment of the invention, the second process makes for less than 5% of tanning of the animal hides, such as less than 2% of the tanning agent contained in the tanned animal hides.

Here the second process refers to post tanning and therefore tanning should be understood as re-tanning.

By makes for the percentage of the tanning of the animal hides should be understood as the percentage e.g. 95% of the tanning agent originates from the first process.

According to an embodiment of the invention, the reduction of post tanning chemicals is at least 5%, such as at least 10%, such as at least 15%, such as at least 20%, such as at least 25%, such as between 10-30%.

Several advantages are obtained by the processes according to embodiments of the invention especially reductions of both the amounts of post tanning agents used during the processes and further a reduction of waste during the processes.

According to an embodiment of the invention, the cross-sectional uniformity of pH in the animal hides in the tanning container is measured at least once during the tanning process for determination of an optional adjustment of the remaining running time of the tanning process.

According to an embodiment of the invention, the first process involving tanning by means of tanning agent is initiated at a certain starting pH of the additives input into the tanning container including the hides to be tanned and wherein the means of obtaining the intended end pH inside the animal hide pH is adjustment of process time and/or process temperature.

According to an embodiment of the invention, the first process involving tanning by means of tanning agent is initiated at a given starting pH of the additives input into the tanning container including the hides to be tanned and wherein the means of obtaining the intended end pH inside the animal hide pH is adjustment of process time and/or process temperature without addition of pH control agent during the first tanning process.

According to an embodiment of the invention, the first process is continued until at least 60% by weight of the tanning agent added into the tanning container during the first process is absorbed and/or loaded into the animal hides, such as at least 70% by weight of the tanning agent, such as at least 80% by weight of the tanning agent.

According to an embodiment of the invention, the tanning process is continued until at least 60% by weight of the tanning agent added into the tanning container during the complete tanning process is absorbed and/or loaded into the animal hides, such as at least 70% by weight of the tanning agent, such as at least 80% by weight of the tanning agent.

According to an embodiment of the invention, the tanning process parameters PP determined initially are applied to run an automated tanning process which is automatically terminated on the basis of the process parameters.

According to an embodiment of the invention, the tanning process parameters PP determined initially are applied to run an automated tanning process which is automatically terminated on the basis of the process parameters and wherein the tanning process is resumed in a further tanning process step after manual and/automatic checks of tanning process conditions.

According to an embodiment of the invention, the tanning the process parameters PP determined initially are applied to run an automated tanning process and where an alarm is automatically provided on the basis of the process parameters to indicate to a user of the initial tanning process step should be interrupted or checked, and where the tanning process is optionally resumed in a further tanning process step after manual and/automatic checks of tanning process conditions.

The invention further relates to a tanned animal hide, wherein the tanned animal hide has a flesh side and a grain side, the two sides defining from the flesh side to the grain side a flesh layer FLA a middle layer MLA and a grain layer GLA, and wherein the animal hide comprises a tanning agent uniformly distributed in weight concentration.

According to an embodiment of the invention, the tanning process is based on a tanning substantially performed with the tanning container under atmospheric pressure and while adding little or less than 10% of water by weight of the hides. When controlled properly, the resulting tanned hide, the leather, may include a significant amount of tanning agent (e.g. chrome) while at the same time producing less wastewater when compared to conventional processes. Even more, the resulting tanned hide, the leather, may be processed so that the middle layer concentration of tanning agent, e.g. chrome, is deviating relatively little from the concentration of tanning agent in the other layers, the grain layer and the flesh layer. It should be noted that the terms grain layer, middle layer and flesh layer may not be a conventional way of describing the tanned hide. It is however noted that the definitions provided in the present context are very easy to understand and apply as the flesh layer refers to the side of the tanned animal hide oriented towards the flesh side and the grain layer refers to the side of the tanned animal hide oriented “outwards”. The middle layer is the part of the tanned hide in-between these layers. The point of defining such layers is that it has turned out that the present tanning method makes it possible to even out the distribution of tanning agent between such layers. This is important as the middle layer in conventional tanning typically incorporate less tanning agent in the middle layer of the tanned hide. This has several implications in the prior art, such implications including e.g. inferior loading of the hide with tanning agent, as the outer layers, the grain layer and the flesh layer, defines the limit for loading in the sense that overload on the surface layers will lead to that the tanned hide is irreversibly made non-applicable for leather.

If, as in the above embodiment of the invention, the tanning agent is distributed more uniformly, it will therefore be possible to load more tanning agent into the animal hide or it may at least be possible to obtain a certain load without destroying the animal hide with respect to the intended use.

According to an embodiment of the invention, the tanned animal hide has a flesh side and a grain side, the two sides defining from the flesh side to the grain side a flesh layer FLA a middle layer MLA and a grain layer GLA, and wherein the animal hide comprises a tanning agent uniformly distributed in weight concentration so that the tanning agent concentration is deviating less than 5% bw between the flesh layer FLA and the middle layer MLA.

According to an embodiment of the invention, the tanned animal hide has a flesh side and a grain side, the two sides defining from the flesh side to the grain side, a flesh layer FLA a middle layer MLA and a grain layer GLA, and wherein the animal hide comprises a tanning agent uniformly distributed in weight concentration so that the tanning agent concentration is deviating less than 5% bw between the grain layer FLA and the middle layer MLA.

According to an embodiment of the invention, the animal hide comprises a tanning agent uniformly distributed in weight concentration so that the tanning agent concentration is deviating less than 6% bw between the flesh layer FLA and the middle layer MLA and less than 6% bw between the grain layer GLA and the middle layer MLA.

In an embodiment of the invention the animal hide comprises a tanning agent uniformly distributed in weight concentration so that the tanning agent concentration is deviating less than 5% bw between the flesh layer FLA and the middle layer MLA and less than 5% bw between the grain layer GLA and the middle layer MLA.

In an embodiment of the invention the animal hide comprises a tanning agent uniformly distributed in weight concentration so that the tanning agent concentration is deviating less than 4% bw between the flesh layer FLA and the middle layer MLA and less than 4% bw between the grain layer GLA and the middle layer MLA.

According to an embodiment of the invention, the tanned animal hide has a flesh side and a grain side, the two sides defining from the flesh side to the grain side a flesh layer FLA a middle layer MLA and a grain layer GLA, and wherein the animal hide comprises tanning agent, the tanning agent including chrome, the chrome being uniformly distributed in weight concentration so that the chrome concentration is deviating less than 5% bw between the flesh layer FLA and the middle layer MLA.

According to an embodiment of the invention, the tanned animal hide has a flesh side and a grain side, the two sides defining from the flesh side to the grain side a flesh layer FLA a middle layer MLA and a grain layer GLA, and wherein the animal hide comprises tanning agent, the tanning agent including chrome, the chrome being uniformly distributed in weight concentration so that the chrome concentration is deviating less than 5% bw between the flesh layer FLA and the grain layer MLA.

According to an embodiment of the invention, the tanned animal hide has a flesh side and a grain side, the two sides defining from the flesh side to the grain side a flesh layer FLA a middle layer MLA and a grain layer GLA, and wherein the animal hide comprises tanning agent, the tanning agent including chrome, the chrome being uniformly distributed in weight concentration so that the chrome concentration is deviating less than 5% bw between the flesh layer FLA and the grain layer MLA.

In an embodiment of the invention, the animal hide comprises a tanning agent uniformly distributed in weight concentration so that the tanning agent concentration is deviating less than 6% bw between the flesh layer FLA and the middle layer MLA and less than bw 6% between the grain layer GLA and the middle layer MLA, the tanning agent including chrome

In an embodiment of the invention, the animal hide comprises a tanning agent uniformly distributed in weight concentration so that the tanning agent concentration is deviating less than 5% bw between the flesh layer FLA and the middle layer MLA and less than 5% bw between the grain layer GLA and the middle layer MLA, the tanning agent including chrome.

According to embodiments of the invention, the total amount of water that can be retained in the animal hide, or the total amount of tanning agent may be calculated based on the initial weight of the animal hide prior to a de-liming step of the animal hide. The animal hide, prior to a de-liming step, has a specific water content, where the water content of the animal hide may depend on e.g. the type of animal hide, the thickness of the animal hide, the size of the animal hide, if the hide is lime split or kept full substance (unsplit) etc. Thus, prior to the de-liming step, the animal hide may be weighed and the initial weight of the animal hide indicates the total amount of water in the hide, as well as the pelt weight, which is the weight of the hide after it has been limed. Furthermore, when the animal hides have been pickled, the weight of the hides may be registered, where the water content of the pickled hides is approximately 100% of the total weight of the water that may be retained by the hide. If the hide is sammed, the weight of the weight of the liquid released from the hide may be registered, or the weight of the sammed hide, so that it is possible to know how much water has to be added to the hide in order to obtain the 100% mark.

Tanning should be understood as a part of the process of treating skins and hides of animal to produce leather. The tanning process alters the protein structure of the skin, making it more durable and less susceptible to decomposition.

“Bovine” as used herein means, with referral to the traditional taxonomic grouping, a group of animals including e.g. cattle, ox, yak etc.

Hide should be understood as the natural skin and hair from an animal e.g. cattle. Hides may be a product from the cattle food industry and can be processed into leather.

Animal hide, pickled pelt and pelt may be used interchangeably and should be understood as the raw material undergoing the processes of e.g. retanning, tanning and post tanning etc. to obtain leather as the final material.

Various exemplary embodiments and details are described hereinafter with reference to the figures when relevant. It should be noted that the figures may or may not be drawn to scale and the figures are only intended to facilitate the description of the embodiments.

### THE FIGURES

The invention will be explained in further detail below with reference to the figures of which

FIG. 1 shows a schematically illustrated embodiment of a process equipment for tanning of animal hides,

FIG. 2 illustrates the steps of pre-tanning, tanning and post tanning of animal hides,

FIG. 3a-b illustrates graphs of tanning agent uptake, exemplified by chromium and where

FIG. 4a-b illustrate the distribution of tanning agent in a tanned hide according to an advantageous embodiment of the invention.

### DETAILED DESCRIPTION

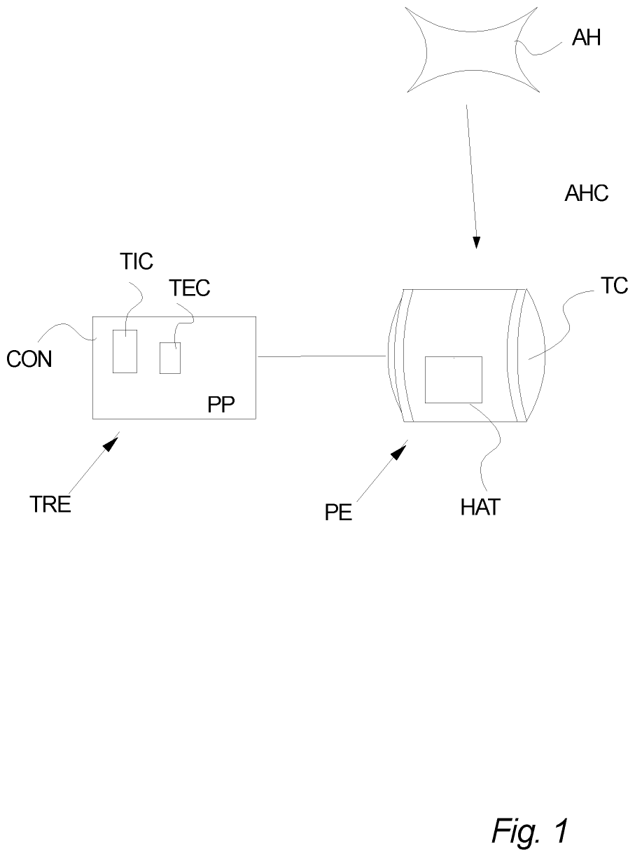

With reference to FIG. 1 an embodiment of a process equipment PE will be explained in detail in the following. The process equipment PE for automatic or semiautomatic tanning of animal hides is schematically illustrated in FIG. 1. At least a part of a tanning process is in an embodiment of the invention executed automatically by a controller CON and performed by process equipment PE under the control of the controller CON on the basis of initially determined process parameters. The part of the tanning process includes preferably at least on initial tanning process step, and optionally a number of repeated further tanning process steps, which may be manually or preferably automatically controlled.

The process equipment PE includes a tanning container TC that may be known from conventional tanning processes and such equipment could be a container or a drum, which may be a big-sized cylindric-shaped machine rotating horizontally on its axis and is large enough to contain several hundred of skin that may weight several thousands of kilos. The tanning container has at least one opening for the addition of animal hides and this opening or another opening may also be used for the addition of tanning agents to the animal hides in the tanning container TC. The tanning container may be a drum, that has a hatch HAT that may be opened to introduce the animal hides, the aqueous solution or the tanning agent. The container may be configured to retain the components used for the tanning process. The process equipment moreover includes temperature regulating equipment TRE establishing the intended temperature in the tanning container under control of the temperature controller TEC. The temperature regulating equipment TRE may typically include at least a heater and preferably also a cooler, or whatever which may be appropriate to heat, optionally cool or at least setting the intended temperature of the content in the tanning container or streams injected into the tanning container.

Drums may be made of wood planking, steel or polypropylene (PPH) drums or any material capable of withstanding deterioration of the material caused by the chemical agents used during the tanning process. An example of a tanning process equipment may e.g. be a PPHTT NJ with AUTOMATIC DOOR PAB/140 by the manufacturer HUni.

As furthermore illustrated in FIG. 1, the tanning process equipment PE may be arranged with different types of control equipment such as a time controller TIC controlling the during of time under which the process equipment works, e.g. duration of tanning cycles, rotations cycles, heating cycles, etc., a temperature controller equipment TEC controlling the temperature in a tanning drum of the system. These controllers may all implemented in a singular or distributed controller CON controlling the automatic operation of the tanning process equipment. PE.

The process parameters PP relevant for executing the process as controlled and monitored by the controller must be based on assumption, measurements or knowledge of certain important data, namely animal hide characteristics AHC. The animal hide characteristics would typically include at least the type/origin of the hide, i.e. a determination or input to the controller defining whether the hides to be tanned are from cow, goat, kangaroo, yak, etc. The animal hide characteristics is further explained below, but at present it is worth to take note, that the tanning process according to an embodiment of the invention depends on the type of hide to be injected. Different types of hide may be more or less loose, may contain more of less collagen, etc., and this will have to be considered in connection with the tanning process.

In principle, it may be important to include or apply test equipment to measure such characteristics and make the data available to the controller CON with little or no human interaction (e.g. calculations) or the characteristics may be determined manually, e.g. simply as skin types, and the relevant process parameters such as process duration, temperature setpoint or temperature development, rotational speed of the tanning drum, rotational direction etc may be input to the controller. Such processing routines may also be included and programmed into or in relation to the controller in order to present a number of preset programs available for the user to select based upon the animal hide characteristics.

A further animal hide characteristic which should be taken into consideration is the weight of the animal hides to be tanned in the tanning container. This weight may be determined manually in input into the controller by a human operator or it may be determined automatically run-time on the basis of data received from a weigh cell associated with the tanning drum

Other animal hide characteristics may be applied within the scope of the invention, but the above should always be brought into use, some way, somehow.

The tanning container TC may be adapted to be heated under control of the controller CON, in order to increase the temperature inside the container to speed up the tanning process and/or to complete the tanning process by fixing of binding the tanning agent e.g. chrome tanning, Wet bright or vegetable tanning to the animal hide. The increase may be from approximately ambient temperature, approximately 20-22 degree Celsius, to between 30-50 degree Celsius. Alternatively, an inclusion of Wet Bright might be utilized to bind the tanning agent to the hide and/or collagen of the hide.

The measurements and control of the temperature during the process according to embodiments of the invention, may be performed by any suitable temperature controller TEC configured for controlling temperature in the tanning container through the tanning process. Such controller may work by measuring the temperature or receiving inputs representing such temperature, and the controller may communicate relevant software control signals to a heater and/or cooler such as a steam inlet in order to achieve a desired temperature in the tanning container TC. The temperature may be measured by one or more temperature sensors measuring the temperature in the tanning container or a derivative thereof and the sensors are communicatively coupled to the controller, thereby facilitating automatic control of tanning control parameters on the basis of the measured temperature values and of course optional further measured values and process parameters PP.

The time may also be preset and controlled during the tanning process. The time controller may be any suitable and programmable time controller and may be connected to the temperature regulating equipment TRE. Such connection may be mediated by a wire or may be wireless. The preset time may cover the total process or at least the duration of time until a first interruption of the tanning process at which e.g. pH is measured, where after the remaining process time may be determined or a time until next interruption is determined.

The pH values may be measured by a pH meter or pH tracer which can be connected to the controller CON or they may be measured manually. Examples of pH meters used in the field of tanning could be a pH tracer (PHT)-ETP. The pH measuring may include measuring of the pH in the additives or the combination of additives and hides in the tanning container.

If required, the pH of the animal hides is to be measured during the process, such pH measuring may typically be measured relatively manual, depending on how exact and how often such measurement is to be made.

pH may be controlled actively by e.g. the addition of base. An example hereof may be the addition of Feliderm MgO into the equipment, where the basification process may be run for e.g. 8 hours for the binding of tanning agent in the animal hides.

pH may also be controlled reactively by the use of a self-basifying tanning agent. An example hereof may be a self-basifying chrome sulphate, such as e.g. Baychrom A.

By use of a self-basifying agent, there may be no need for an additional basifying agent, and the basifying may be obtained by increasing the heat inside the equipment. In fact, any compound that can raise the pH of the tanning solution to a value higher than 4.0 can be considered as a candidate to be the basifying agent.

The control of pH may be run automatically or at least partially automatic by means of the controller CON. In other embodiments, such a control of pH may be effected by interrupting the tanning process or programming intervals at which pH measuring and optional supplementary pH control is performed. Such a process would typical by effected by an active control of pH as explained above.

The control of pH may also be run as a hybrid active and reactive process, e.g. by starting out with a self-basifying tanning agent including pH controlling agents and then subsequently during the tuning process tuning the pH by actively adding pH controlling agent, e.g. after measurement of pH in the drum and/or pH of the hides performed at intervals during the process.

The process is performed at atmospheric pressure, or optimally where the pressure inside the container is substantially similar to the pressure surrounding the container. Optionally the process may be performed in a non-pressurized container. This means that the pressure inside is maintained similar to that of the surrounding, without actively increasing it during the tanning process. However, it may be foreseen that an increase in temperature inside the tanning equipment may change the pressure inside the container slightly and at is advantageous that the tanning equipment is not airtight or has a safety valve that opens if the pressure increases during the processes. If the pressure inside the container rises above 1.2-2 atmospheres it may be seen as hazardous, both to machinery and the operators working with the machinery. Alternatively, the container may be provided with an air valve that opens every time the valve is above the centre line of the tanning equipment e.g. the container or rotating drum, while the valve closes when it extends below the centre line.

According to embodiments of the invention, the container may be a closed system during the tanning process. The container may be understood as a container capable of holding the animal hide, any water and/or aqueous solution that is used for the tanning process, any tanning agent that is introduced in dry, solid, liquid, wet or in any form, without changing the concentrations of the components inside the tanning equipment.

The process parameters PP may be determined based on an initially assessment of the animal hide characteristics AHC. Here, several parameters must be taken into account when setting such process parameters PP as there may be great variations of the starting point and consequently the process parameters for running an optimal tanning process resulting in a uniform distribution of tanning agents.

Such variations may be the weight and/or thickness e.g. of a lime split or full substance of the animal hides, where a thick and dense animal hide may need e.g. longer time, or a higher temperature compared to a thinner animal hide. Further, there are also great differences of the characteristics between the skins from different animals e.g. cattle and a crocodile, or even within the same race e.g. calf, veal, heavy veal, cow, bull, ox etc. Other variations of the starting point of the animal hides may also be if the animal hides are salted or not, how well dehydrated the animal hides are, how much hair and/or fat present on the hides, the amount of animal hides that are to be processed.

When the process parameters are determined, based on e.g. the above described examples of animal hide characteristics, the automatic tanning process for tanning animal hides can be initiated and carried out at least partly automatic.

A tanning process based on the animal hide characteristics is then set up e.g. as a manual for the operators of the tanning process including specifications of e.g. the amount of water, selection and concentration of chemicals, temperature of eater inlet, running time, drum speed, rotation direction etc. Such tanning process is setup to run automatically, however, control steps may be included during the process wherein e.g. pH is measured throughout the cross section of the animal hides to control if it is in the correct range. Such pH measure may be done by cutting the hide and measuring pH with a pH indicator of the cross section, e.g. layers as grain, middle and flesh to make sure there is an even pH distribution throughout the layers. The results during the control steps may then lead to a fixed direction for the next step. Powders may also be added manually to the process. Process control steps to check the pH of the cross section/layers indicators may be used where: Phenolphthalein <8,2 Colorless >8,2 Pink and/or Broomcresol Green <3,8 Yellow >5,4 Blue etc.

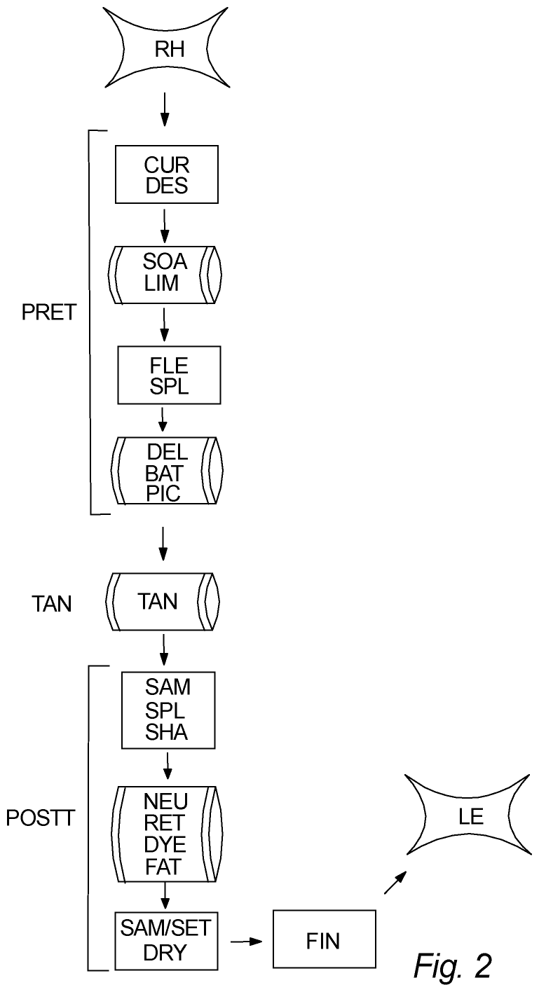

In FIG. 2 the steps of pre-tanning, tanning and post tanning animal hides are shown. Several steps are needed in order to prepare the hides for the tanning process. Preparing or pre-tanning PRET hides begins by curing CUR with salt to prevent putrefaction of the collagen from bacterial growth during the time lag from procuring the hide to when its processed. Curing removes water from the hides and bacterial are unable to grow. The step of curing CUR may be done at a slaughterhouse or supplier before it reaches the tanning facilities. The step of curing may be optional where a part of a production is salted, and the remaining are fresh hides. Curing CUR may be followed by a desalting DES.

The hides are then soaked SOA in clean water that may contain additives such as e.g. degreasing, soda, enzymes, and/or bactericides in a soaking step, where the salt left from curing is removed and the moisture in the hides is increased. Soaking takes place at pH between 8 and 10.

In the liming step LIM, sulphur compounds as well as lime, enzymes and/or degreaser may be added to remove the hair of the hide. The proteins are hydrolysed, i.e. rendered water soluble, and washed off. At the same time, the lime and the sulphur compounds used in the liming step, which have a powerful reducing effect, attack and rupture the polypeptide chains of the leather hide leading to greater mobility of the fibers, which gives the leather an enhanced extensibility and softness. This process may also be known as hide opening. During the entire liming process, the hide undergoes a process of swelling due to becoming highly anionically charged and the attendant repellence between groups bearing the same charge. The isoelectric point of the collagen in the hide is also shifted to about pH 5-6 due to liming.

After liming fleshing FLE is made and during the fleshing step, remnants of tissue, flesh and fat are removed using sharp bladed rolls. To obtain uniformly thick leather in a desired thickness, the hide can be split SPL. Fleshing and splitting are performed individually for each hide by hand and machine combined. The step of splitting may be done on a separate machine/separate step as some hide batches may be split and others may not. The untanned leather may also be known as a pelt. A pelt has a water content of 60%-80% and the dry matter contains approximately 98% collagen.

The swelling induced in the liming process, by the high alkalinity, has to be eliminated before tanning and by a deliming process, the pH of the collagen is reduced. During deliming the calcium hydroxide in the hide is removed by adding weak organic acids, e.g. aliphatic or aromatic dicarboxylic acids such as e.g. sulphophthalic acid or by adding weakly inorganic salts, such as e.g. ammonium sulphate, ammonium chloride or polyphosphates. In deliming, the calcium hydroxide in the hide is removed.

Optionally and depended on the end use of the leather, the hide may be treated with enzymes to soften them, in a process called bating BAT. Deliming and bating are performed in a somewhat heated float, i.e. at 30 to 35 degree Celsius.

Pickling PIC is the process where hides and skins are treated first with common salt (sodium chloride) and then with sulfuric acid, in the case of a mineral tanning. This is done to bring down the pH of collagen to facilitate the penetration of tanning agent. The bating process may take between 45 minutes to 6 hours at pH of 8-9 and the pickling process may take approximately 5 to 12 hours at pH 2.8 to 5, such as 2.8 to 3.2 for a standard pickle process.

The hide obtained after bating BAT and pickling is fully saturated with aqueous solution and is known as a pickled pelt.

Hereafter, the actual tanning TAN is carried out, conventionally taking 12 to 48 hours and often carried out in rolling drums. Tanning may elsewhere be referred to as a first process.

In addition to water and tanning agent, the tanning solution may contain e.g. salt, formic acid, sulphuric acid, sodium bicarbonate and may have additional compounds. During tanning, the bonding-capable groups on the collagen undergo crosslinking with the tanning agents. The pH may be raised to values between 3.6 to 4.2 e.g. by addition of alkali or by using a self-basifying tanning agent.

As an example, the basification may be performed by the introduction of 0.4-0.6% (36.5 kg) Feliderm MgO into the tanning that may be added in several steps, where the basification process may be run for eight hours to bind the tanning agent in the animal hides, e.g. in case of Chromosal B is being used as a tanning agent.

Tanning agents may be any suitable tanning agent for tanning animal hides including but not limited to chromium sulphate and its derivates, vegetable extracts, glutardialdehyde, fatty oils in particular and other mineral salts based on aluminium, zirconium, titanium, iron, silicates, etc. and synthetic tanning agents based on acrylics, acrylic copolymers, triazine, polyphenols, polysulphonic acids and condensates thereof, etc.

The tanning agent may further comprise additional components such as Fungicides (Busan 1280), or other additives that may provide additional qualities to the tanned leather or the tanning process. The tanning agent may include other additives such as e.g. electrolyte stable fatliquors, cationic/fatliquor or slippery agents. The tanning agent may be provided to the container in any form, where each component is introduced separately or in a mixture, which may be in solid or liquid form.

Examples of commercially available tanning agents are Chromosomal B and Baychrome A.

Other compounds may also be used during the tanning process and these compounds may be sodium sulphide, sodium hydroxide, sodium hydrosulfite, arsenic sulphide, calcium hydrosulfide, dimethyl amine and sodium sulphydrate. Biocides such as e.g. pentachlorophenol may also be added to prevent bacterial growth.

After the tanning process, the hides may also be sammyed SAM, split SPL and shaved SHA. Sammying SAM is the process that reduces the humidity to 45-65% by passing the hide through e.g. rollers. Splitting is the process, where leather can be passed through a splitting machine, which slices thicker leather into two layers. The layer without a grain surface can be turned into suede or it can have an artificial grain surface applied. A uniform thickness can be achieved by shaving the leather on the non-grain side using a machine with helical (spiral shaped) blades mounted on a rotating cylinder.

According to embodiments of the invention, the animal hide may be sammed and/or where the water retained in the animal hide is reduced to approximately 50-90% of the total water that can be retained by the pickled animal hide, prior to providing the animal hide in the container. If the animal hide is sammed prior to the introduction into the container, to remove parts of the pickling solution from the animal hide, it may be seen as being important to introduce an additional aqueous solution, pickle solution and/or water into the container. The sammying of the animal hide may assist in cleaning the animal hide, where the sammying removes fibres from the animal hide or absorbs grease. The sammying machines absorb the grease and humidity from the hide during the wet process in tanneries, either wet blue, wet white or vegetable. The sammying machine may be equipped with 2 or 3 or 5 or 6 pressure rollers that press the hide in order to take out the fats and/or the water content. The hide is conveyed on felts through the sammying machines which absorb the fats and/or the water content and as well the pressure by the rollers.

Hereafter, the steps of post tanning POSTT animal hides refers to the processing steps that follow the primary tanning reaction and are carried out as additional processes of making leather. Post tanning may elsewhere be referred to as a second process.

Neutralization NEU removes any residual chemicals and prepares the animal hides for further processing. Additional tanning or retanning RET may be applied to add more tanning agent such as e.g. chrome, to provide the hide with optimal properties required in the finished leather. Retanning can involve many different types of chemical reactions. These include mineral tanning with mineral salts (including chromium(III) applied to chrome tanned leather), aldehydic reagents, hydrogen bondable polymers, electrostatic reactions with polymers or resins or any other type of synthetic tanning agents (syntan). During retanning it may be the same tanning agents that are used as during the tanning process. The tanning agents may also not be the same during the tanning and retanning process. The dyeing DYE of leather into a wide variety of colours play an important role for aesthetic appearances and an important part in meeting fashion requirements. Some leathers are only surface dyed, while others are dyed by a completely penetration of dye. Fatliquoring FAT is the step of introducing oil to the animal hides to lubricate the fibers for keeping the leather flexible and soft. Setting out SEO/sammed SAM, as earlier described, and drying DRY may also be applied during post tanning.

The post tanning process involves neutralization of the cationic charge of the chrome tanned animal hides by elevating the pH of the animal hides to 4.5-6.5

Several finishing steps FIN may follow the steps of post tanning, such as e.g. conditioning, staking, dry drumming/milling, buffing, brushing, surface coating etc. (not shown)

The process time of the tanning process varies according the tanning agents and tanning reactions, where the chrome tanning itself is typically less than 24 hours and vegetable tanning may take within 24 hours or several weeks, even in a modern process. During the processes of tanning the hide, a uniform distribution of tanning agents, e.g. chrome, throughout the hide both from the grain side to the inside and from the flesh side to the inside is important to make sure that the outcome of the tanning process is optimal. Too much chrome can result in an overload of chrome in the hides and may result in an unwanted green colouring of the skin. Too little chrome may result in that some of the layers of the skin is well-loaded and when other layers, such as the inside of the hide, are essentially not tanned.

During the tanning process the tanner must balance the competing process rates of rate of penetration and rate of reaction. If the rate of penetration is faster than the rate of fixation, the tanning agent is likely to penetrate all the way through the pelt, but may not be fixe, depending on the degree to which the system is made unreactive by the pH conditions in pickling. If opposite, the system is too reactive, would result in excessive fixation on or at the surface, potentially leading to a raw centre in the pelt. The ideal situation is where rate of penetration is the same or similar as the rate of reaction and leading to the most uniform fixation through the pelt, although the actual concentration profile through the cross section will depend on the initial pH profile. The penetration time of a tanning process within an embodiment of the invention may e.g. be 3 to 6 hours and fixation time may e.g. be 6 to 8 hours.

The rates are controlled in large part by the pH, time, temperature profiles drum speed, drum direction and chrome amount, so the conditions in the beginning of the reaction and the end of the reaction are adjusted accordingly.

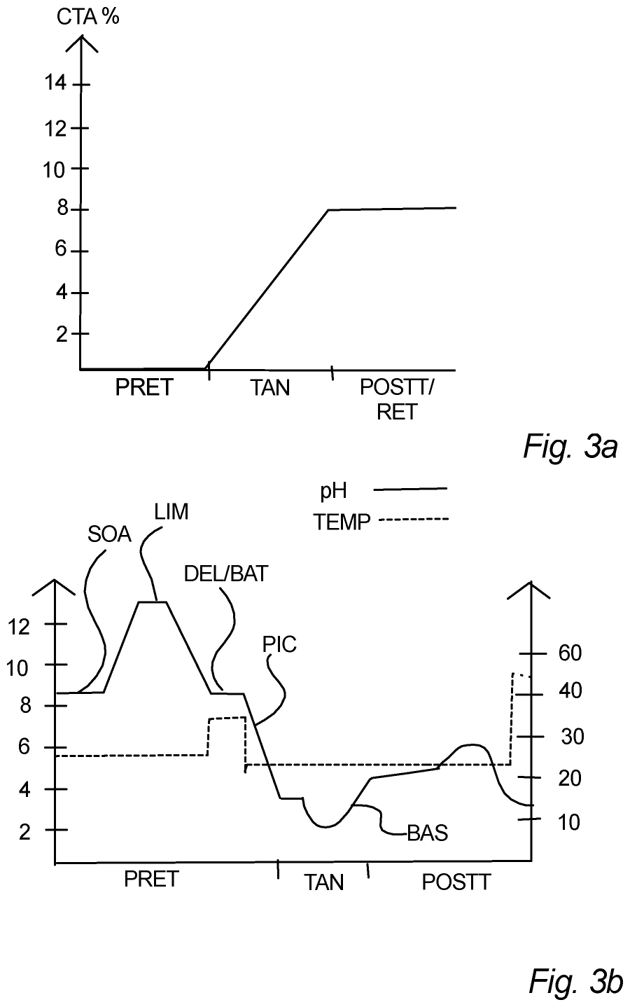

FIG. 3a shows an exemplified graph for the illustration of the variation of the concentration of tanning agent (e.g. chrome) in the animal hides during the pretanning process, tanning process and post tanning (retanning). Here, the tanning process relates to the process where tanning agent, here exemplified with chrome, is taken up and bound to the reactive sites of the collagen in the animal hides. The graph illustrates that during the tanning process, the chromium is taken up efficiently due to the optimal process parameters PP according to embodiments of the invention. Because of the efficient and high load of chromium during the tanning process, it may not be necessary to make additional re-tanning/re-chroming in the post tanning process POSTT according to an advantageous embodiment of the invention.

FIG. 3b shows an exemplified graph for the illustration of the pH and temperature TEMP during the processes. pH and temperature may vary according to different tanning methods.

The soaking and liming steps during pre-tanning (PRET) may take place at pH between 7 and 10 or higher, e.g. liming LIM up to pH 12-13 where after the deliming (including bating) may take place at pH 6.5-9 and then the hides are subjected to pickling by e.g. using 10% salt and 1% mineral acid, in order to bring down the pH of the delimed hides from approximately pH 6.5-9 to pH 2.5-5 (such as between 2.75 and 3.25) to facilitate uptake as well as penetration of tanning agent (e.g. chromium sulfate). pH is subsequently raised to 3.6 to 4.2 for fixation, which is also known as basification BAS.

Basification, or raising the pH during the tanning process, has the effect of ionising the carboxyl groups on the collagen and this is the mechanism by which the reactivity of the system is increased. The mechanism of allowing chrome to fix on the collagen can be regarded as a one-way reaction, since the bonding is effectively irreversible. Above the typical end point of basification, usually pH 3.8-4.0, there is a danger zone, consisting of the maximum allowed pH, leading to a precipitation point.

Temperatures during soaking SOA and liming LIM may be between 20-30 degrees Celsius, during deliming DEL and bating the temperature may be between 30-40 degrees Celsius, during pickling PIC the temperature may be 20 degrees Celsius, during tanning TAN the temperature may be between 20-25 degrees Celsius, during basification BAS the temperature may be between 25-50 degrees Celsius, dependent on the different tanning methods, during post tanning POSTT processes such as wash, neutralization, retanning and dye the temperature may be between 20-30 degrees Celsius and then during fatliquring FAT and fixing e.g. top dye the temperature may be between 40-50 degrees Celsius.

Conditions at the beginning and end of a chrome tanning process may be start pH at 2.5-5 at ambient temperature, e.g. 15-25 degrees Celsius, with a slow reaction rate and fast penetration rate. And finish pH at 3.6-4.2 with elevated temperature, e.g. 30-55 degrees Celsius, with a fast reaction rate and a slow penetration rate. Here, the term ambient as applied to temperature is, of course, relative; in considering initial conditions of tanning account must be taken of local conditions, when the temperature might be lower or more likely higher than the range exemplified here. For example, in the hight of summer in some parts of the world, the ambient and municipal water temperature may be significantly higher than 25 degrees Celsius, whence tanners sometimes resort to the addition of ice before tanning can start.

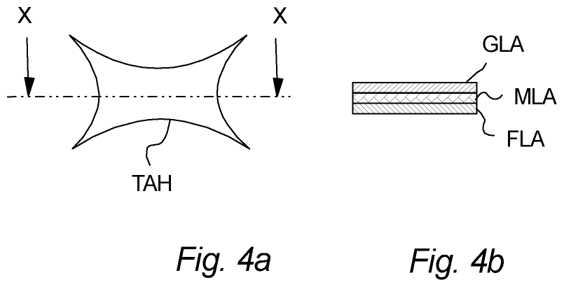

FIGS. 4a and 4b illustrate a cross-section of a tanned animal hide TAH at the line X-X. The tanned hide TAH has a grain layer GLA, a flesh layer FLA and a middle layer MLA in between the grain layer and the flesh layer. It should be noted that the terminology leash layer may lead the reader to expect that the layer is constituted of flesh as such. That is however not the case. In the present context a flesh layer of a tanned animal hide is simply named to indicate the orientation of the layer with respect to the middle layer.

According to an embodiment of the invention, the tanning process is based on a tanning substantially performed with the tanning container under atmospheric pressure and while adding little or less than 10 of water by weight of the hides. When controlled properly, the resulting tanned hide, the leather, may include a significant amount of tanning agent (e.g. chrome) while at the same time producing less wastewater when compared to conventional processes. Even more, the resulting tanned hide, the leather, may be processed so that the concentration of tanning agent in the middle layer MLA, e.g. chrome, is deviating relatively little from the concentration of tanning agent in the other layers, the grain layer GLA and the flesh layer FLA when compared to conventional tanning methods.

By being able to load tanning agent, e.g. chrome, at a relatively high level into the middle layer MLA according to a preferred embodiment of the present invention, it will be possible to load the complete crossection of the hide relatively high without risking overloading and thereby damaging the flesh and/or the grain layer irreversibly.

This is an important aspect of the present embodiment of the invention as the process of tanning the animal hides if performed with little or maybe even no addition of water to the hide provides a very efficient penetration of tanning agent, e.g. chrome, into the hide, including the middle layer if pH and amount of applied tanning agent, e.g. chrome, is applied properly.

Typically, it is strongly preferred in this particular low-water tanning process, to avoid adjustment of pH during the tanning process as is may be difficult to distribute e.g. a pH controlling agent evenly in the tanning container and thereby in the animal hide as the pH controlling agent should not or cannot be diluted much within the provisions of the invention. If a pH adjustment is absolutely necessary, a self-basifying tanning agent should be applied, but it is preferred to avoid such pH adjustment.

A tanning process within the provisions of an embodiment of the present invention may be said to be full-filled when the first addition of tanning agent has been applied to the tanning contained, the tanning process has been terminated with a sufficient amount of tanning agent penetrated into the animal hide, the intended pH has been reached and the tanned hides have been or are to be removed from the tanning container.

In an embodiment of the invention, the animal hides tanned according to the embodiment of the invention, excluding an optional post-tanning process, reaches a chrome content of said animal hides of 3.5-8% bw of said animal hides, such as 3.5-6% bw of said animal hides at the time the tanned hides are removed from the tanning container.

In a very advantageous embodiment re-tanning should be avoided, whether this is happening as a repetition of the tanning process with the use of a new water stream, but it is in particular advantageous to establish a sufficiently load of tanning agent (resulting in a so-called rich leather) during to first tanning process without any need of subsequently requiring a re-tanning included in the post tanning. This is advantageous as a re-tanning including tanning agent such as chrome, will result in wastewater and increased requirement for handling of wastewater. In other words, the present invention makes it possible to establish a high load of tanning agent with a significant reduction of waste materials, not least the waste materials usually provided through the post-tanning when this process includes a re-tanning.

The distribution of the chrome throughout the hide can be tested in different ways such as e.g. solely by visual inspection where a green colour of the hide shows an overload of chrome in the hides. The chrome content can also be measured more precisely by e.g. in the chemical lab by a method such as NEN 6961: 2005 (Dutch standard).

All percentages are based on the basis weight of animal hides unless otherwise stated.

It is noted that bw, unless otherwise provided, refers to “by weight”.

### LIST

AH Animal hide
PE Process equipment
TC Tanning container
TEC Temperature controller
TIC Time controller
CON Controller
AHC Animal hide characteristic
PP Process parameters
HAT Hatch
PRET Pre-tanning
RH Raw hide
CUR Curing
DES Desalting
SOA Soaking
LIM Liming
FLE Fleshing
SPL Splitting
DEL Deliming
BAT Bating
PIC Pickling
TAN Tanning
SAM Sammying
SPL Splitting
SHA Shaving
POSTT Post tanning
NEU Neutralization
BAS Basification
RET Retanning
DYE Dyeing (drum)
FAT Fatliquoring
SAM Sammying
SEO Setting out
DRY Drying
FIN Finish
LE Leather
TEMP Temperature
PH pH
CTA Concentration tanning agent

### EXAMPLES

The following examples 1-2 are examples of tanning processes using the following parameters:
Time: 2-12 Hours Penetration
Temp: 34-44 Degree Celsius
pH: 2.8-4.4
Amount: 4-8% Chrome

The chrome content in these examples were measured in the chemical lab by the method NEN 6961: 2005 (Dutch standard).

### Example 1

Example 1 shows examples of the chrome content distribution throughout the hide. Chrome in different concentrations were used the tanning process. In table 1 8% Chromosomal B tanning was used during a tanning process and in table 2 6% Baychrome A was used during a tanning process.

TABLE 1
Chrome content of different locations on a hide.

| Location in hide | Chrome content |
|---|---|
| Grain | 4.26 |
| Middle | 3.60 |
| Flesh | 5.03 |

In table 1 it is shown that using 8% of Chromosomal B resulted in an un-uniform distribution of chrome throughout the hide resulting in a higher concentration of chrome on the outsides of the hide compared to the inside of the hide.

TABLE 2
Chrome content of different locations on a hide.

| Location in hide | Chrome content |
|---|---|
| Grain | 5.44 |
| Middle | 5.32 |
| Flesh | 5.33 |

In table 2 it is shown that using 6% of Baychrome A resulted in a uniform and acceptable distribution of chrome throughout the hide.

TABLE 3
Specifications of Chromosomal B and Baychrome A

| | Chromosal B | Baychrom A |
|---|---|---|
| Cr2O3 Content | 26% | 21% |
| Basicity | 33% | 67% |

### Example 2

Example 2 shows examples of maximum chrome content and distribution throughout the hide. Three different concentrations of the chrome tanning agent Baychrome A (6.5%, 7.5% and 8.5%) were used during the tanning process and illustrating different outcomes of distribution throughout the hide.

TABLE 4
Maximum chrome content and distribution throughout the hide

| Chrome | Chrome | | |
|---|---|---|---|
| tanning agent | content of pelt | | Average |
| (percent by | (percent by | Location | chrome |
| pelt weight) | pelt weight) | in hide | content |
| 6.5% | 4.85 | Grain | — |
| | 4.54 | Middle | 4.89 |
| | 5.29 | Flesh | — |
| 7.5% | 5.55 | Grain | — |
| | 5.67 | Middle | 5.70 |
| | 5.89 | Flesh | — |
| 8.5% | 5.36 | Grain | — |
| | 5.74 | Middle | 5.73 |
| | 6.10 | Flesh | — |

Percent by weight chrome tanning agent should by understood as e.g. 6.5% of the product/tanning agent (here Baychrome A) is added the tanning process calculated based on the pelt weight. As shown in table 3, the tanning agents contains 21% chromium (chromium oxide Cr2O3) of the 6.5% product which means that the concentration of chrome, in this example, is 21% chrome of 6.5% product=1.365% chrome in the product. The chrome content of the pelt is also calculated based on the pelt weight, however at this stage the pelt contains less water, and therefore lower weight of the pelt, as there has been a water reduction during both the deliming and samming process.

In table 4 it is shown that by adding 7.5% chrome tanning agent (Baychrome A), the chrome is both high loaded and uniformly distributed throughout the cross section of the animal hide.

Further it is shown that higher concentrations of chrome e.g. 8.5% during the tanning process did not result in additional chrome content inside the hide compared to e.g. a concentration of 7.5% chrome during a tanning process.

1. A tanning process for tanning of animal hides in a process equipment, the process equipment including: a tanning container, a controller, and temperature regulating equipment, the controller controlling a temperature in the tanning container based on temperature setpoint input to or established by the controller the tanning process comprising steps of:
initially determining process parameters on the basis of animal hide characteristics including at least animal hide type and animal hide weight, the process parameters including at least one of: time, temperature, start pH and end pH, or any combination thereof; and
executing the tanning process of the animals hides based on the process parameters in the tanning container under atmospheric pressure,
adding tanning agents to the animal hides in the tanning container; and
adding water in an amount of less than 10% bw of the animal hides.

2. The tanning process according to claim 1, wherein the animal hides tanned according to the process parameters, excluding a post-tanning process, reach a tanning agent content of said animal hides of 3.5-12% bw of the animal hides.

3. The tanning process according to claim 1, wherein the animal hides tanned according to the process parameters excluding the post-tanning process, reaches a tanning agent content of said animal hides of 3.5-12% bw of said animal hides, and
wherein the tanning agent is chrome.

4. The tanning process according to claim 1, wherein the adding of water is in an amount of less than 8% bw of the animal hides.

5. The tanning process according to claim 1, wherein the adding of water is in an amount of between 3% to less than 10% bw of the animal hides.

6. The tanning process according to claim 1, wherein the steps of the tanning process are a first process, and
wherein the tanning process further comprises a second process that is a subsequent post-tanning process.

7. The tanning process according to claim 6, wherein the animal hide has a flesh side and a grain side, the two sides defining from the flesh side to the grain side: a flesh layer a middle layer and a grain layer, and
wherein the animal hide comprises a tanning agent uniformly distributed in weight concentration after the first process.

8. The tanning process according to claim 1, wherein a concentration of the tanning agent deviates less than 6% bw between the flesh layer and the middle layer and less than 6% bw between the grain layer and the middle layer.

9. The tanning process according to claim 1, wherein the tanning process further includes a post-tanning process including processes of neutralization, retanning, dyeing, fatliquoring, setting out, and/or sammying.

10. The tanning process according to claim 9, wherein the animal hides are tanned according to the process parameters including the post-tanning process, reaches a chrome content of the animal hides of between 3.5-12% bw of the animal hides.

11. (canceled)

12. The tanning process according to claim 9, wherein the animal hide tanned according to the tanning process, including the post-tanning process, has a tanning agent content of animal hides of between 5.5-12% bw of animal hides, and
wherein the tanning agent is uniformly distributed through a cross section of the tanned hide.

13. The tanning process according to claim 1, wherein the tanning process is an automatic tanning process.

14.-16. (canceled)

17. The tanning process according to claim 1, wherein a preset process parameter of time is between 2-24 hours.

18.-27. (canceled)

28. The tanning process according to claim 6, wherein the post tanning process comprises at least one of: neutralization (NEU), retanning (RET), dyeing (DYE), fatliquoring (FAT), sammying (SAM), setting (SEO), or drying (DRY).

29.-30. (canceled)

31. The tanning process according to claim 6, wherein the first process makes for at least 95% of the tanning agent contained in the tanned animal hides.

32.-33. (canceled)

34. The tanning process according to claim 6, wherein chemicals in the post-tanning are reduced by at least 5%.

35.-36. (canceled)

37. The tanning process according to claim 6, wherein the first process involving tanning by means of tanning agent is initiated at a given starting pH of the additives input into the tanning container including the animal hides to be tanned, and
wherein obtaining the intended end pH inside the animal hide pH is obtained by adjusting a process time and/or process temperature without addition of pH control agent during the first tanning process.

38.-39. (canceled)

40. The tanning process according to claim 1, wherein the process parameters determined initially are applied to run an automated tanning process which is automatically terminated based on the process parameters.

41. The tanning process according to claim 1, wherein the process parameters determined initially are applied to run an automated tanning process which is automatically terminated based on the process parameters, and
wherein the tanning process is resumed in a further tanning process step after manual and/automatic checks of tanning process conditions.

42. The tanning process according to claim 1, wherein the process parameters determined initially are applied to run an automated tanning process and where an alarm is automatically provided based on the process parameters to indicate to a user of the initial tanning process step should be interrupted or checked, and where the tanning process is optionally resumed in a further tanning process step after manual and/automatic checks of tanning process conditions.

43. A tanned animal hide, wherein the tanned animal hide has a flesh side and a grain side, the two sides defining from the flesh side to the grain side: a flesh layer, a middle layer and a grain layer, and wherein the animal hide comprises a tanning agent uniformly distributed in weight concentration.

44.-49. (canceled)
